(19) United States
(12) Patent Application Publication
(10) Pub. No.: US 2009/0327850 A1
(43) Pub. Date: Dec. 31, 2009

(54) PUBLISHING SYSTEM

(75) Inventors: Cliff Obrecht, Hillarys (AU); Melanie Perkins, Duncraig (AU)

Correspondence Address: GANZ LAW, P.C., P O BOX 2200, HILLSBORO, OR, 97123, US

(73) Assignee: FUSION BOOKS PTY LTD, Duncraig (AU)

(21) Appl. No.: 12/181,262

(22) Filed: Jul. 28, 2008

(30) Foreign Application Priority Data
Jun. 26, 2008 (AU) 2008903266

(51) Int. Cl. G06F 17/21

(52) U.S. Cl. 715/210; 707/103 R; 707/E17.009

(57) ABSTRACT

A publishing system and method for producing a print ready electronic publication, the system comprising a data storage device arranged to store structure data indicative of the structure of a publication and content data indicative of content usable in the publication; the system being arranged to facilitate creation of a publication structure by a first user group comprising at least one first user, the publication structure being arranged to receive publication content; and the system being arranged to facilitate reception of content from a second group of users including at least one second user; wherein the content and location of the content in the publication structure is selectable by one or more first user from the content received from the second user group.

### RELATED APPLICATIONS

Under 35 U.S.C. 119, this application claims priority to and the benefit of Australian patent application number 2008903266 filed Jun. 26, 2008, the contents of which are hereby incorporated by reference as if listed herein in its entirety for all purposes.

### FIELD OF THE INVENTION

The present invention relates to a publishing system and to a method of producing a print ready electronic publication.

### BACKGROUND OF THE INVENTION

It is known to provide a computer implemented publishing system for creating print ready documents. An operator is able to use the system to define page layouts and determine the content to be included on each page. Such a computer implemented publishing system is often referred to as a “desktop publishing” system.

However, it is often difficult to coordinate content for inclusion in a document especially in situations wherein many contributors are associated with creation of the document.

### SUMMARY OF THE INVENTION

In accordance with a first aspect of the present invention, there is provided a publishing system for producing a print ready electronic publication, the system comprising:
a data storage device arranged to store structure data indicative of the structure of a publication and content data indicative of content usable in the publication;
the system being arranged to facilitate creation of a publication structure by a first user group comprising at least one first user, the publication structure being arranged to receive publication content; and
the system being arranged to facilitate reception of content from a second group of users including at least one second user;
wherein the content and location of the content in the publication structure is selectable by one or more first user from the content received from the second user group.

In one arrangement, at least one first user is also included in the second user group.

The data storage device may comprise an images repository arranged to store a plurality of images received from at least the second user group.

In one embodiment, the system is arranged such that images stored in the images repository are selectable for inclusion in the publication structure by a first user.

The system may be arranged to facilitate modification of a stored image such as by cropping and/or resizing of the stored image.

In one arrangement, the data storage device comprises a database which may be a relational database.

In one embodiment, the system comprises a plurality of predefined project themes, each project theme defining a global theme for the publication to be produced by the publishing system and the project theme being selectable by a first user.

In one embodiment, the publication structure comprises a plurality of predefined page types, each page type being configured to receive content, and the system being arranged to facilitate selection of one or more predefined page types for inclusion in the publication structure. The predefined page types may include an article page configured to receive one or more articles written by one or more second users; a photo page configured to receive one or more images; a profile page configured to receive information specific to second users such as answers to questions put to second users and images relevant to the second users; a passport photos page configured to receive passport type photos; a group photo page configured to receive group photos; a question & answer page configured to receive questions to be put to second users and answers received from the second users; a poll page configured to receive multiple choice questions to be put to second users and answers received from the second users; a before & after page configured to receive images of people at different times; an autograph page having one or more spaces intended to receive hand written messages on the printed document; and/or a graphic page configured to receive graphic design type images.

In one embodiment, the system is arranged such that for at least one page type, at least one second user is selectable by a first user to contribute content to the page type. The system may also be arranged such that for at least one page type, all second users associated with the publication are automatically assigned a task of contributing to the page type.

In one embodiment, the system is arranged such that each user has associated unique login details usable to facilitate access to the system by the user and determine the level of access permitted.

In one embodiment, the system is arranged so as to communicate to a second user when the second user has been selected by a first user to contribute to a page type. The communication may be in the form of an email and the communication may provide the second user with relevant login details usable by the second user to access the system.

In one arrangement, the system is arranged such that when a second user accesses the system, a list of page types in respect of which the second user has been selected to contribute is displayed.

The system may be arranged to facilitate modification of the order of the page types in the publication, for example by dragging identifiers representing the page types on a display so as to modify the order of the identifiers and thereby the order of the page types associated with the identifiers, for example using a mouse.

In one embodiment, the system is arranged to automatically create a table of contents based on the page types included in the publication and the order of the identifiers on a display.

In one embodiment, the system comprises a web interface arranged to facilitate communications between the system and the first and second users through the Internet, for example by serving web pages to a computing device associated with the first or second user.

In accordance with a second aspect of the present invention, there is provided a publishing system for producing a print ready electronic publication, the system comprising:
a data storage device arranged to store structure data indicative of the structure of a publication and content data indicative of content usable in the publication;
a plurality of predefined page types, each page type being configured to receive content;
the system being arranged to facilitate selection of one or more predefined page type for inclusion in a publication structure;
the system being arranged to facilitate reception of content; and
the received content and location of the received content in the publication structure being selectable by one or more user.

In accordance with a third aspect of the present invention, there is provided a method of producing a print ready electronic publication, the method comprising:
storing structure data indicative of the structure of a publication and content data indicative of content usable in the publication;
creating a publication structure by a first user group comprising at least one first user, the publication structure being arranged to receive publication content;
receiving content from a second group of users including at least one second user; and
selecting content to be included in the publication from the received content and the location of the selected content in the publication structure by one or more first user.

In accordance with a fourth aspect of the present invention, there is provided a method of producing a print ready electronic publication, the method comprising:
storing structure data indicative of the structure of a publication and content data indicative of content usable in the publication;
providing a plurality of predefined page types, each page type being configured to receive content;
selecting one or more predefined page type for inclusion in a publication structure;
receiving content from one or more user associated with the system; and
selecting the content to be included in the selected page types from the received content and the location of the received content in the publication structure.

### BRIEF DESCRIPTION OF THE DRAWINGS

The present invention will now be described, by way of example only, with reference to the accompanying drawings, in which:

FIG. 1 is a schematic diagram of a publishing system in accordance with an embodiment of the present invention;

FIG. 2 is a schematic diagram illustrating an example database structure of the system shown in FIG. 1;

FIGS. 3 to 24 are diagrammatic representations of screens produced by the system shown in FIG. 1 during use; and

FIG. 25 is a flow diagram illustrating a method of producing a print ready electronic publication according to an embodiment of the present invention.

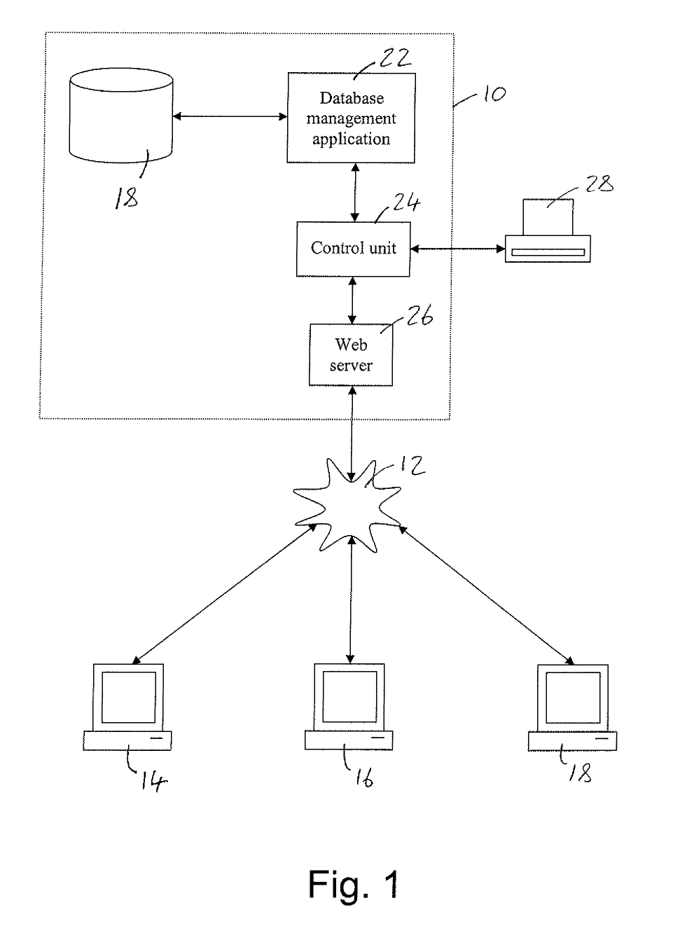

### DESCRIPTION OF AN EMBODIMENT OF THE INVENTION

Referring to the drawings, there is shown a publishing system 10 which is arranged to facilitate structured and organized creation of a print ready document using content provided by at least one contributor. This is achieved by permitting document framework creation and editing tasks to be carried out by at least one editor, and by assigning contribution tasks but not global editing permissions to at least one contributor. In this way, by ensuring that a limited number of people have document creation and editing tasks while allowing any number of people to contribute to the content of the document, control over creation of the document is maintained.

The present publishing system 10 is implemented online such that the or each editor is able to define the structure of the document to be published from a remote location and the or each contributor is able to upload content to be added to the document from a remote location.

The system 10 in this example is accessible from a remote location through a communications network such as the Internet 12 using any suitable communication enabled device. In this example, first, second and third computing devices 14, 16 and 18 respectively are shown, although it will be understood that any number of computing devices may be present.

In this example, the first computing device 14 is associated with an editor given the task of creating a framework for a document and editing the document based on content provided by contributors, and the second and third computing devices 16, 18 are associated with contributors given the task of contributing content to the document.

The system 10 comprises a database 18 arranged to store content provided by contributors, information indicative of the structure of a project, in particular the layouts of pages forming part of the project and the specific content included on the pages, and information indicative of editors and contributors associated with the system 10. In this example, in order to simplify storage of the information, the data is stored in a relational database structure and a database management application 22 is provided to manage storage and retrieval of data to and from the database 18.

The system 10 also includes a control unit 24 for controlling and coordinating operations in the system 10, and a web server 26 for communicating with the Internet 12, in particular for serving web pages to the computing devices during creation and editing of a project and uploading of data from the contributors.

The system 10 in this example is connected directly to a printer 28 arranged to receive print instructions from the control unit 24 indicative of a document to be printed. In a variation of this embodiment, instead of providing a printer 28 at the same location as the publishing system 10, the printer 28 may be disposed remotely relative to the system 10, for example connected to the system 10 through the Internet 12.

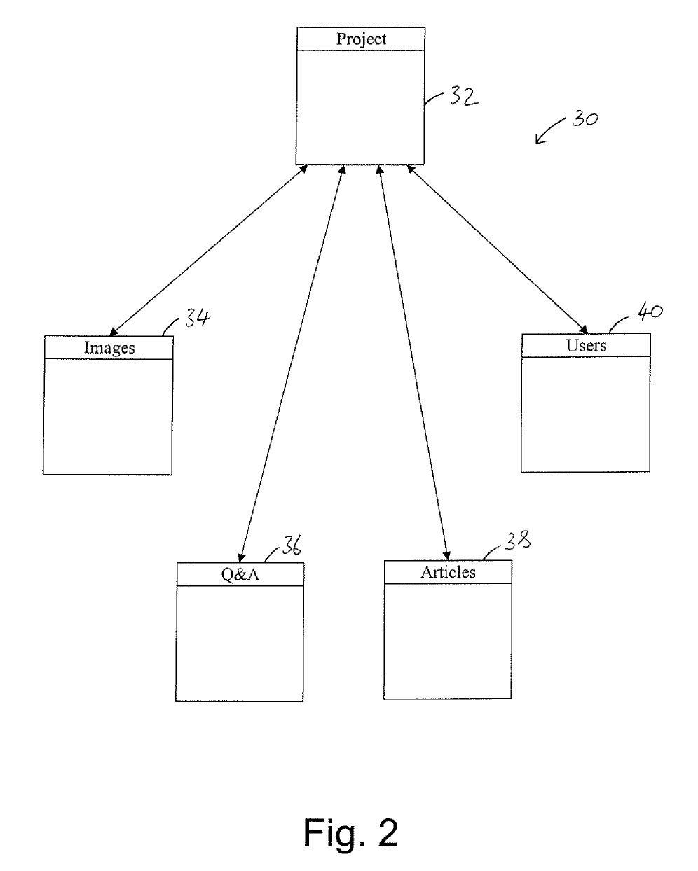

An example database structure 30 is shown in FIG. 2. The database structure 30 includes a plurality of relational databases including a primary project database 32 and secondary databases linked to the primary database. In this example, the secondary databases include an images database 34 arranged to store all images uploaded to the system 10 from contributors; a Q&A database 36 arranged to store all questions and responses which may be included in a document to be created by the system 10; an articles database 38 arranged to store all articles added to the system by contributors; and a users database 40 arranged to store information indicative of all editors and contributors associated with the system 10 such as names and email addresses, and details of the relevant portions of the project in relation to which the contributors are required to add content. However, it will be appreciated that any other secondary database may be included instead of or in addition to the secondary databases shown in FIG. 2, the important aspect being that all data associated with a project to be created by the system 10 is appropriately stored and linked.

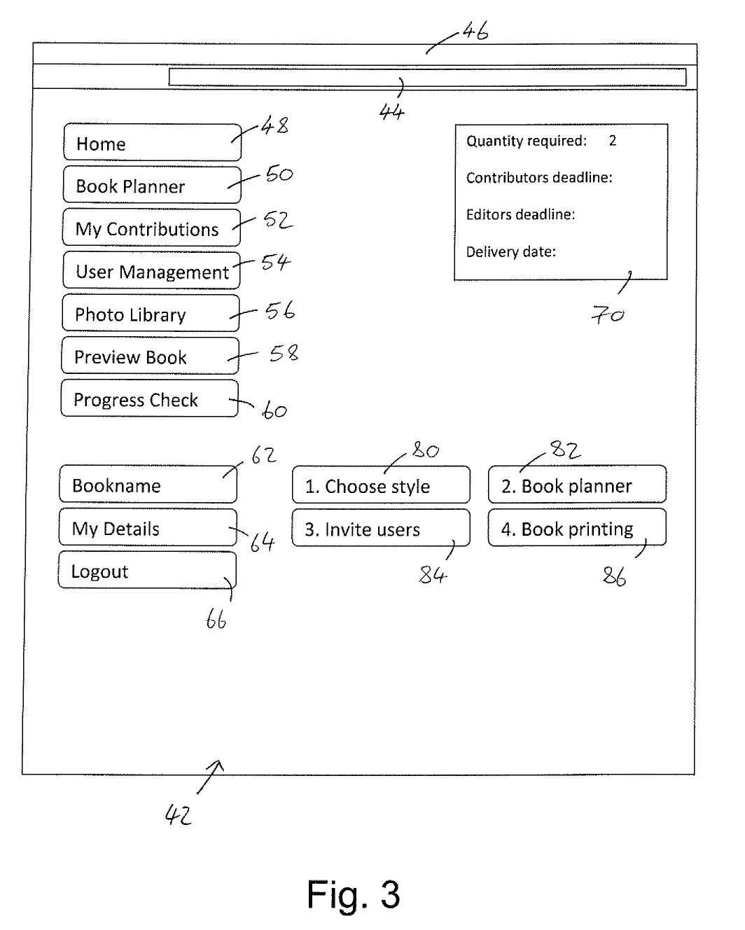

FIGS. 3 to 24 show representations of screens served to users by the web server 26 during use. Like and similar features shown in the Figures are indicated with like reference numerals.

In order to distinguish between editors and contributors, the system 10 is arranged to permit access to the system 10 only after a valid login has occurred, with each user being allocated a different login name with associated privileges and access rights depending on whether the user is an editor or contributor.

While the system identifies a user as either an editor or contributor, it will be understood that an editor may also act as a contributor in that some content to be included in a project created by the system 10 may be the responsibility of the editor.

FIG. 3 shows a representation of an editor home page 42 which is served to an editor at a computing device 14 when a website address 44 associated with the system 10 is entered into a browser window 46 and the editor has logged into the system 10.

The editor home page 42 includes several navigation buttons which are visible on many of the screens served to the editor. The navigation buttons comprise a home button 48 usable to direct the browser to display the editor home page 42, a book planner button 50, a contributions button 52, a user management button 54, a photo library button 56 usable to view all images uploaded to the system by contributors, a preview book button 58, a progress check button 60, a bookname button 62 usable to define the name of the project, a my details button 64 usable to modify user personal details such as a user password, and a logout button 66. Operation of these buttons is discussed in more detail below.

The editor home page 42 also includes a deadlines information box 70 which indicates to the editor relevant information and deadlines for the project, such as how many documents are to be produced, the relevant deadline for contributors to provide content, the relevant deadline for the editor to finalize the page layout and included content, and a delivery deadline by which the publication is desired to be printed.

In the present example, the system is applied to creation of a school yearbook wherein an editor or team of editors associated with the school are appointed and the contributors to the project are drawn from students and teachers of the school.

The editor home page 42 also includes task buttons 80, 82, 84, 86 which are included to assist the editor to adopt a structured approach to the project. In this example, the structured approach involves four stages. In a first stage initiated by activating a choose style task button 80, for example using a mouse, the editor selects an underlying style for the project, that is, the graphical theme for the project, the fonts to be used for the project and so on. In a second stage initiated by activating the book planner navigation button 50 or a book planner task button 82, the editor defines the page types to be included in the project and configures the pages, for example so as to define the page layouts, the fonts used for contributed content, and where appropriate selects content provided by contributors to be included on the pages, and so on. In a third stage initiated by activating an invite users task button 84, the editor assigns to contributors specific contribution tasks to provide content for the project. In a fourth stage initiated by activating a book printing task button 86 and which occurs after the editor has finalized all editing tasks, the editor causes the project to be printed.

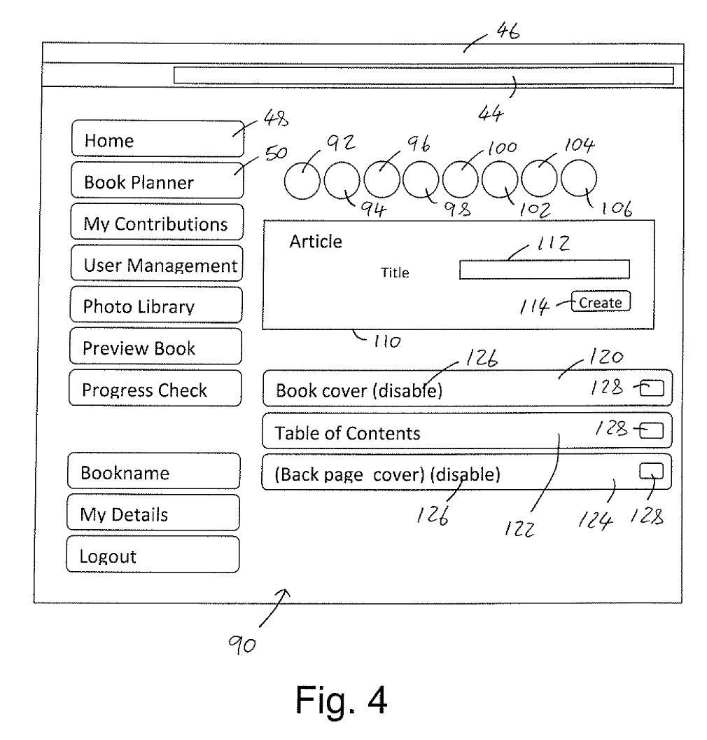

Activation of the book planner navigation button 50 or the book planner task button 82 causes a book planning page 90 as indicated in FIG. 4 to be displayed.

The book planning page 90 includes several page type buttons usable to create different types of pages to be included in the project. In this example, the page type buttons comprise an article button 92 usable to create a page configured to receive one or more articles written by one or more contributors; a photo button 94 usable to create a page configured to receive one or more images; a profile button 96 usable to create a page configured to receive information specific to contributors such as answers to questions put to contributors and photos relevant to the contributors; a passport photos button 98 usable to create a page configured to receive passport type photos from contributors; a group photo button 100 usable to create a page configured to receive group photos from contributors, in the present example such as a class photo; a question & answer button 102 usable to create a page configured to receive questions to be put to contributors and answers received from the contributors; a poll button 104 usable to create a page configured to receive multiple choice questions to be put to contributors and answers received from the contributors; and a before & after button 106 usable to create a page configured to receive images of people, in this example students, at different times. However, it will be understood that any suitable page type button may be included in order to facilitate creation of a page of specific type. For example, an autograph button may be included and used to create a page having one or more spaces intended to receive hand written messages on the printed document, or a graphic button usable to create a page configured to receive graphic design type images.

The book planning page 90 is arranged such that a create page box specific to a page type is displayed when a mouse icon is disposed over the page type button associated with the page type. For example, as shown in FIG. 4, disposing a mouse icon over the article button 92 causes an article page creation box 110 to be displayed.

Using the page creation box 110, an editor is able to enter a title for the new page in a title box 112 and confirm creation of the page by activating a create button 114.

In a similar way, an editor is able to create and name other page types by disposing a mouse icon over the appropriate page type button and entering the title for the new page in the title field.

The book planning page 90 also includes at least one page bar 120, 122, 124 associated with a corresponding created page in the project. Each page bar is usable to configure the page associated with the page bar, such as selection of a page layout, insertion of content into the page from content uploaded by contributors, and so on.

In the present example shown in FIG. 4, a book cover page, table of contents page and a back cover page are automatically created by the system and, accordingly, a book cover page bar 120, a table of contents page bar 122 and a back cover page bar 124 appear on the book planning page 90. The page bars include enable/disable toggle fields 126 usable to cause the associated pages to appear or not appear in the printed project. Each of the page bars also includes a configure page button 128 usable to open a respective configuration page.

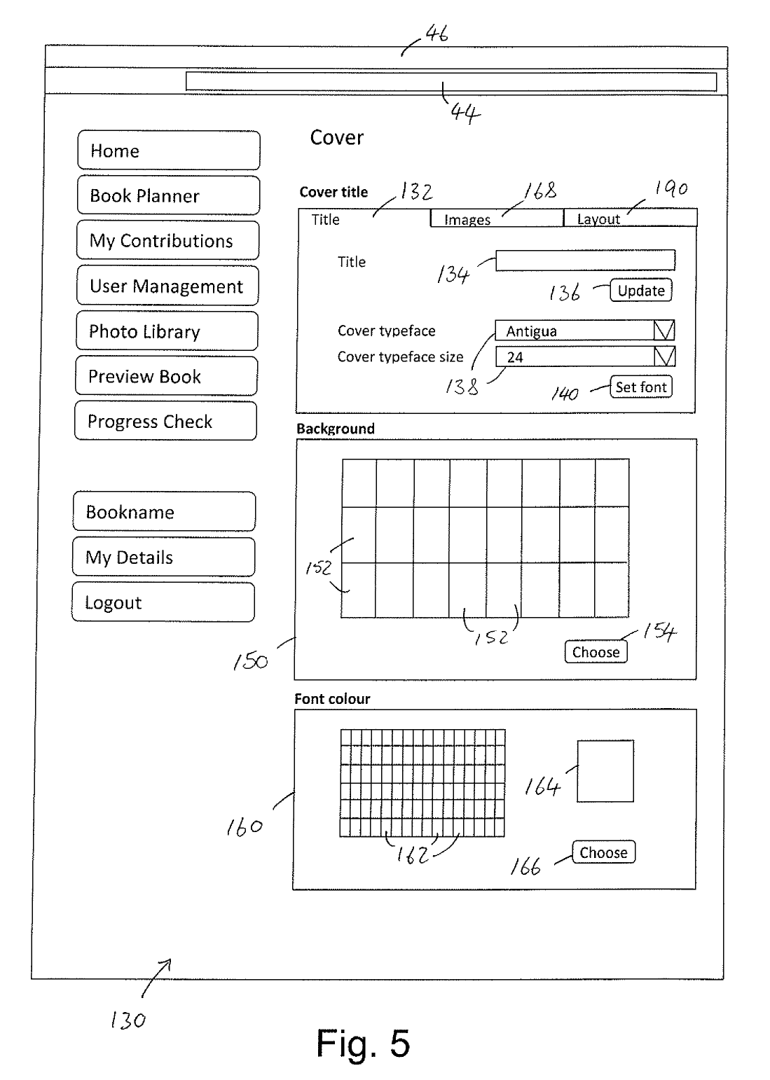

Activation of the configure page button 128 associated with the book cover page bar 120 causes a cover configuration page 130 to be displayed, as shown in FIG. 5.

The cover configuration page 130 includes a cover title tab 132 which when selected enables the editor to enter a cover title into a cover title box 134, confirm title selection with an update button 136, select cover typeface type and size using typeface dropdown boxes 138, and confirm selection of the typeface using a set font button 140.

The cover configuration page 130 also includes a background selection box 150 usable to select the background theme for the cover page from a plurality of available themes 152, and to confirm selection of the theme using a choose button 154.

The cover configuration page 130 also includes a font colour selection box 160 usable to select the font colour for the cover page from a plurality of available colours 162, to view a preview of the font colour in a preview box 164, and to confirm selection of the font colour using a choose button 166.

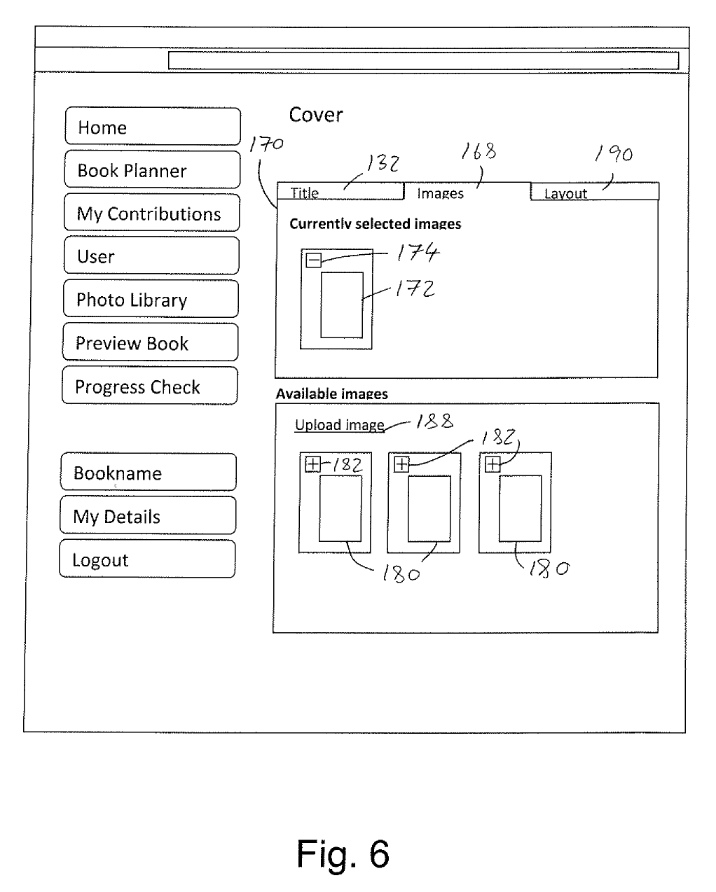

The cover configuration page 130 also includes a cover images tab 168 which when selected enables the editor to select one or more images 172 to be made available for inclusion on the cover page. As shown in FIG. 6, selected images 172 may be made unavailable for inclusion on the cover page by clicking on a deselect icon 174, and images 180 which have been uploaded to the system 10 may be selected and thereby made available for inclusion on the cover page by clicking on a select image icon 182.

Additional images may be uploaded to the system and thereby made selectable by selecting an upload link 188.

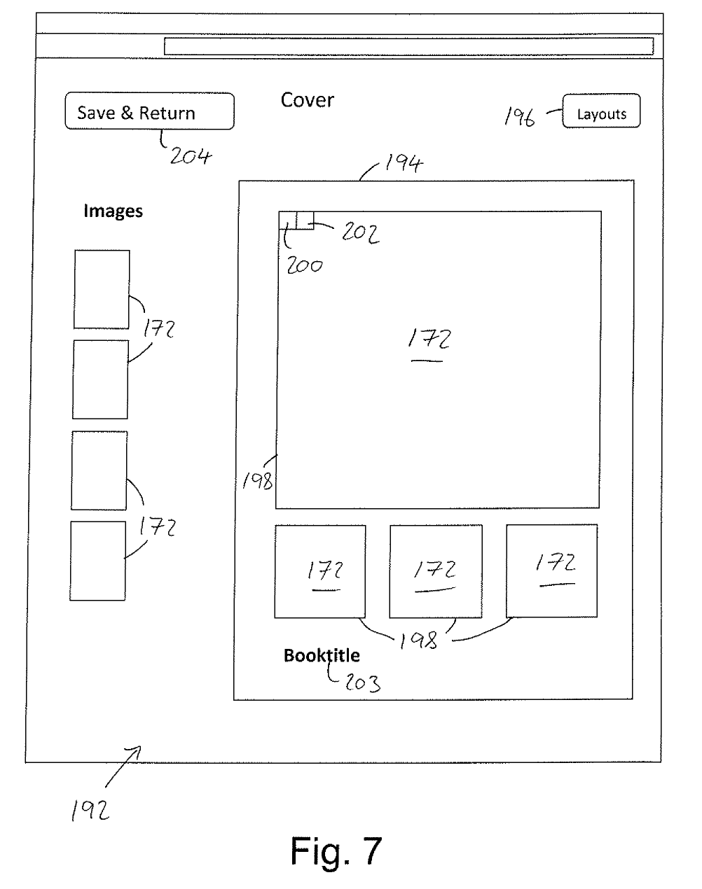

The cover configuration page 130 also includes a cover layout tab 190 which when selected enables the editor to configure the layout of the cover page. Selection of the cover layout tab causes display of a cover layout page 192, as shown in FIG. 7. The cover layout page 192 includes a cover layout box 194 showing a representation of a selected cover page layout, and a layout selection button 196 usable to cause display of several possible page layouts and enable an editor to select one of the layouts to use for the cover page.

The selected layout represented in the cover layout box 196 includes several regions 198 each of which is arranged to receive an image from the bank of selected images determined using the cover images tab 168 shown in FIG. 6. An image 172 may be added to a selected region 198 by dragging the image 172 to the region 198.

Each region 198 in the cover layout box may also include a crop icon 200 usable to crop the image to be displayed in the region, and a delete icon 202 usable to delete the image from the region 198.

In this example, the layout represented in the cover layout box 194 also includes a cover page title 203 created using the cover title tab 132 shown on Page 5, and a save button 204 usable to confirm the images added to the cover page.

A similar process occurs when the configure page button 126 associated with the back cover page bar 124 is activated in order to allow an editor to define the configuration of the back page and add selected images if desired to the back page.

The process for creation of specific page types by an editor to be included in the project will now be described with reference to FIG. 4 and FIGS. 8 to 15.

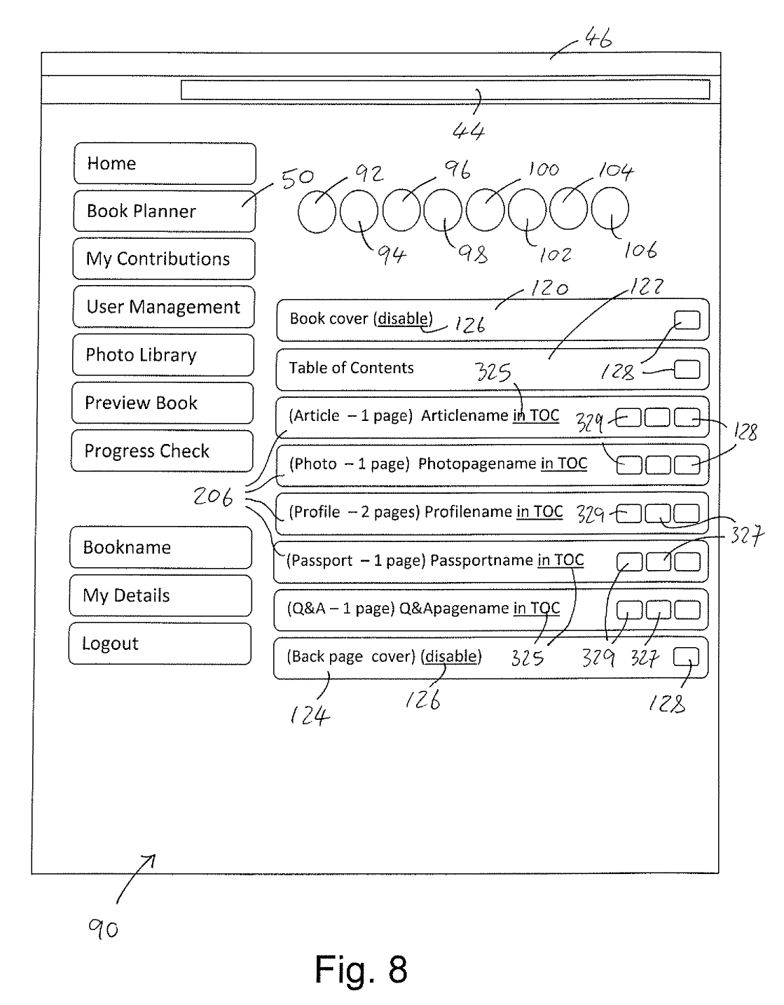

As described above, a new page is created using the page creation box 110 on the book planning page 90, and after creation of the new page, a page bar associated with the new page appears on the book planning page 90. A representation of a book planning page 90 including several new page bars 206 associated with added pages is shown in FIG. 8. By dragging page bars 206, for example using a mouse, an editor is able to change the order of the page bars 206 on the book planning page, and thereby the order of the pages in the printed project.

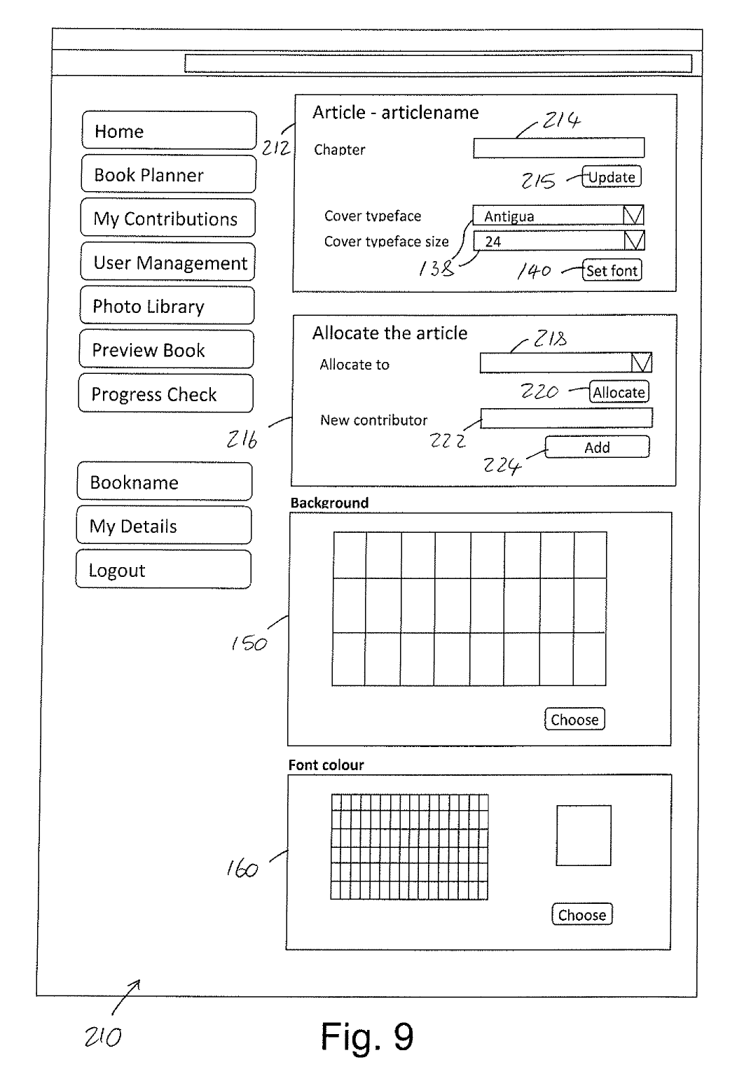

In order to configure a newly added article page, the editor selects a configuration button 208 on the article page bar 206 associated with the article page which causes an article page 210 to be displayed, as shown in FIG. 9.

The article page 210 includes an article details box 212 usable to modify the article page title by entering a new title into an article title box 214 and confirm the title with an update button 215. As with the cover configuration page shown in FIG. 5, the typeface type and size to use for the article page are selectable using typeface dropdown boxes 138, and the selection is confirmed using a set font button 140.

As with the cover configuration page 130, the article page 210 also includes a background selection box 150 usable to select the background theme for the article page, and a font colour selection box 160 usable to select the font colour for the article page from a plurality of available colours 162.

The article page 210 also includes an allocate article box 216 having an allocate drop down box 218 usable to select one or more contributors associated with the system 10 that the editor desires to write the article. If the desired contributor is not already associated with the system and therefore does not appear in the drop down box 218, a new contributor may be added by entering an email address of the new contributor in a new contributor box 222 and confirming the new contributor by clicking on an add contributor button 224.

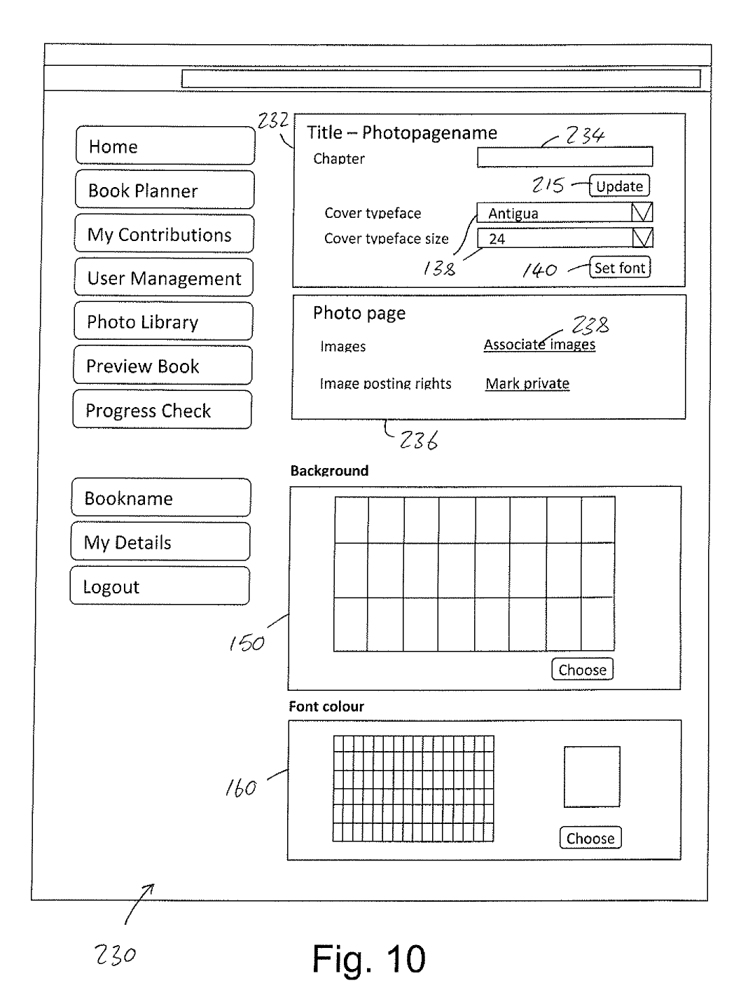

Similarly, in order to configure a newly added photo page, the editor selects a configuration button 208 on the photo page bar 206 on the book planning page 90 which causes a photo page 230 to be displayed, as shown in FIG. 10.

The photo page 230 includes a photo details box 232 usable to modify the photo page title by entering a new title into a photo title box 234 and confirm the title selection with an update button 215. As with the article configuration page 210 shown in FIG. 9, the typeface type and size to use for the photo page are selectable using typeface dropdown boxes 138, and the selection is confirmed using a set font button 140.

As with the article page 210, the photo page 230 also includes a background selection box 150 usable to select the background theme for the photo page, and a font colour selection box 160 usable to select the font colour for the photo page from a plurality of available colours 162.

The photo page 230 also includes an associate images box 236 usable to select one ore more photos to be included on the photos page. The page layout is defined and the photos to include on the photos page are selected from available uploaded images in a way similar to the process described in relation to the cover page with reference to FIGS. 6 and 7.

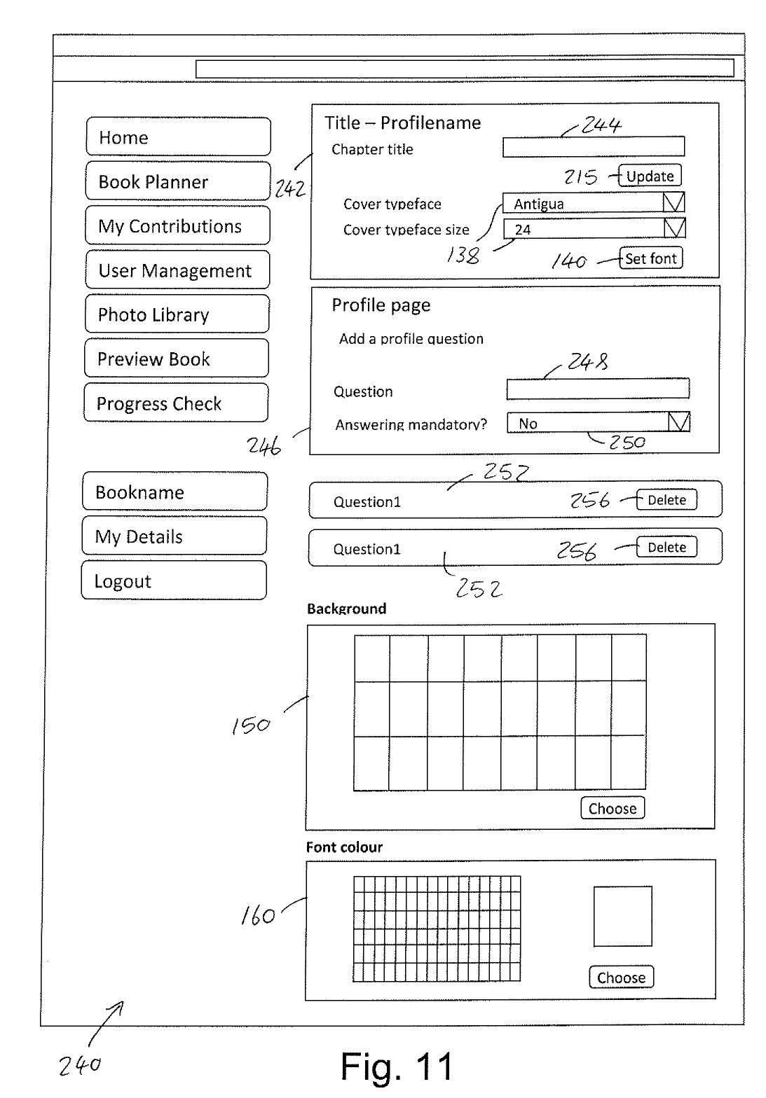

Similarly, in order to configure a newly added profile page, the editor selects an edit configuration button 208 on the profile page bar 206 on the book planning page 90 which causes a profile page 240 to be displayed, as shown in FIG. 11.

The profile page 240 includes a profile details box 242 usable to modify the profile page title by entering a new title into a profile title box 244 and confirm the title selection with an update button 215. As with the article configuration page 210 shown in FIG. 9, the typeface type and size to use for the photo page are selectable using typeface dropdown boxes 138, and the selection is confirmed using a set font button 140.

As with the article page 210, the profile page 240 also includes a background selection box 150 usable to select the background theme for the profile page, and a font colour selection box 160 usable to select the font colour for the profile page from a plurality of available colours 162.

The profile page 240 also includes a profile question box 246 having a question field 248 usable to add questions to the profile and a drop down box 250 usable to define whether answering the question is mandatory.

After creating one or more questions, the questions appear on the profile page in respective question bars 252. Each question may be deleted by clicking on a delete button 256 in the question bar 252. The order of the questions may be changed by dragging the question bars 252.

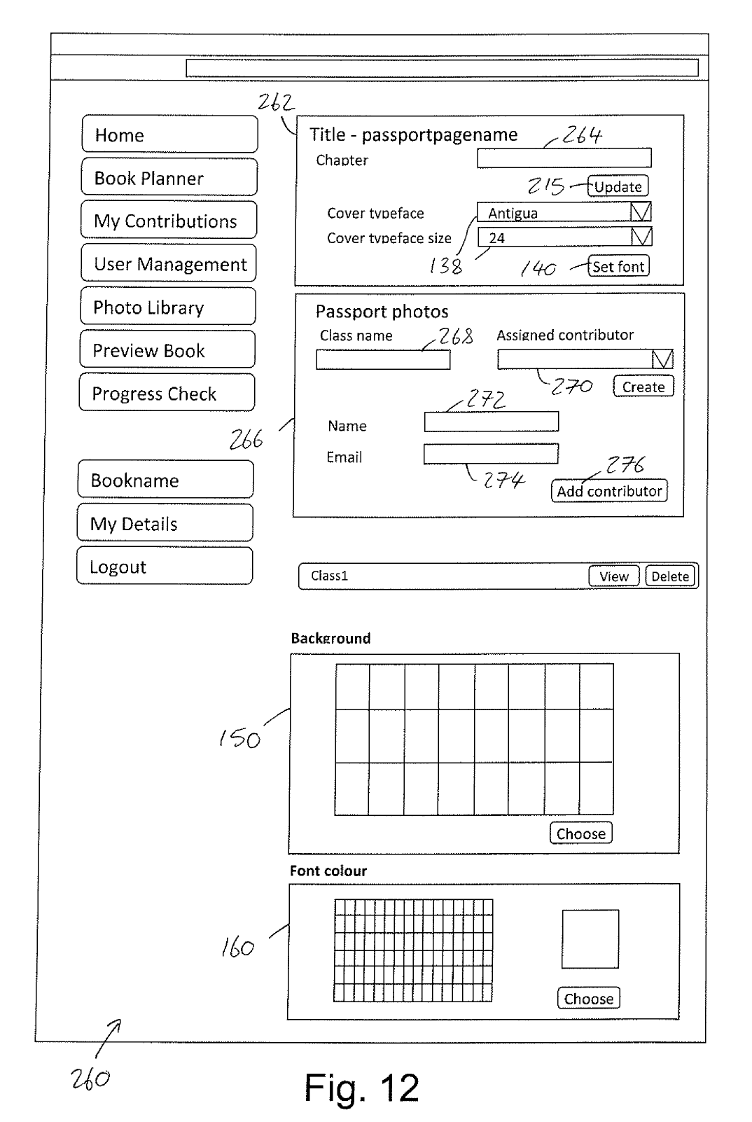

Similarly, in order to configure a newly added passport photo page, the editor selects an edit configuration button 208 on the passport photo page bar 206 which causes a passport photo page 260 to be displayed, as shown in FIG. 12.

The passport photo page 260 includes a passport details box 262 usable to modify the passport photo page title by entering a new title into a passport title box 264 and confirm the title selection with an update button 215. As with the article configuration page 210 shown in FIG. 9, the typeface type and size to use for the passport photo page are selectable using typeface dropdown boxes 138, and the selection is confirmed using a set font button 140.

As with the article page 210, the passport photo page 260 also includes a background selection box 150 usable to select the background theme for the passport page, and a font colour selection box 160 usable to select the font colour for the passport page from a plurality of available colours 162.

In this example, passport photos are organized in classes, for example such that all passport photos for a class are displayed on one page. Using a class creation box 266 on the passport photos page 260, the editor is able to create a class page for each class to be included in the project and to allocate a contributor to the class to collate all passport photos and upload the photos to the system 10. In this way, responsibility for obtaining all passport photos for a class is placed with one contributor. The passport photos page 260 includes a class photos box 266 having a class name field 268 for entering the name of a class and a contributor drop down box 270 usable to select a contributor to be given the responsibility for uploading passport photos to the system 10. Contributor name and email fields 272, 274 and an add contributor button 276 are also included to enable the editor to add new contributors to the system if the desired contributor is not included in the drop down box 270.

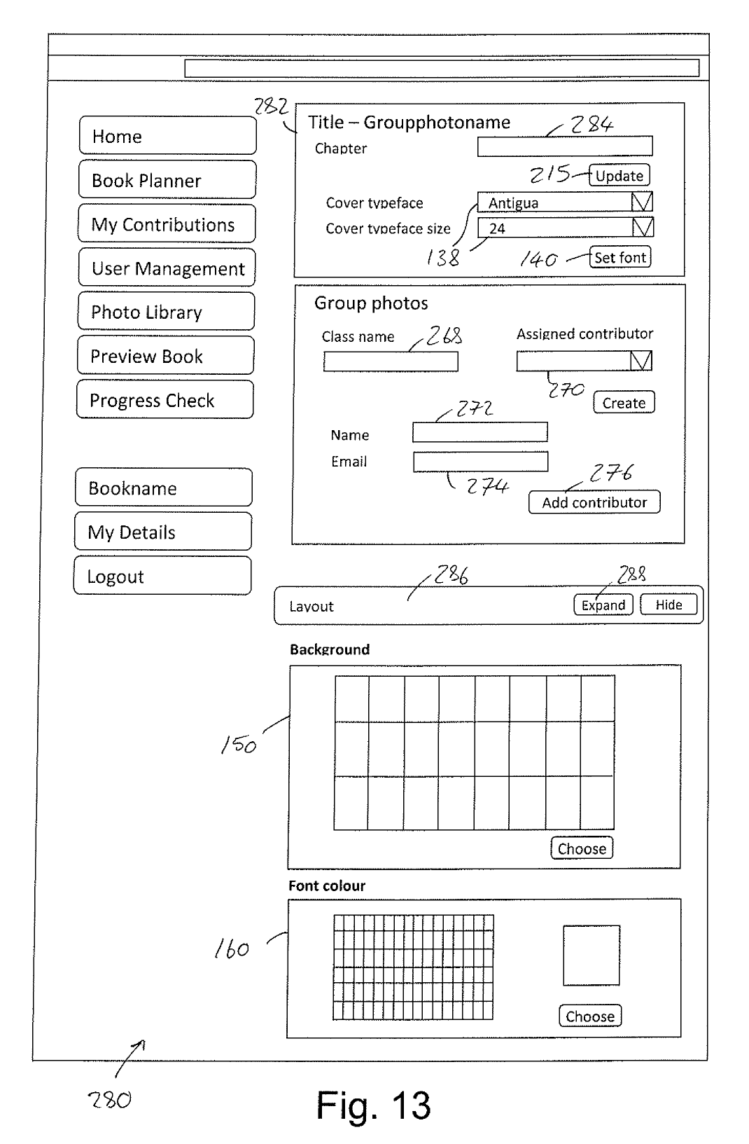

Similarly, in order to configure a newly added group photo page, the editor selects a configuration button 208 on the group photo page bar 206 on the book planning page 90 which causes a group photo page 280 to be displayed, as shown in FIG. 13.

The group photo page 280 includes a group details box 282 usable to modify the group photo page title by entering a new title into a group title box 284 and confirm the title selection with an update button 215. As with the article configuration page 210 shown in FIG. 9, the typeface type and size to use for the group photo page are selectable using typeface dropdown boxes 138, and the selection is confirmed using a set font button 140.

As with the article page 210, the group photo page 280 also includes a background selection box 150 usable to select the background theme for the group photo page, and a font colour selection box 160 usable to select the font colour for the group photo page from a plurality of available colours 162.

In this example, group photos are organized in classes, for example such that the group photo for each class is displayed on one page. As with the passport photos page 260, using a class creation box 266 on the passport photos page 260, the editor is able to create a class page for each class to be included in the project and to allocate a contributor to the class to organize uploading of a group photo to the system 10.

The group photo page 280 also includes a layout bar 286 which when expanded by clicking on an expand button 288 can be used to select a page layout for the group photo page.

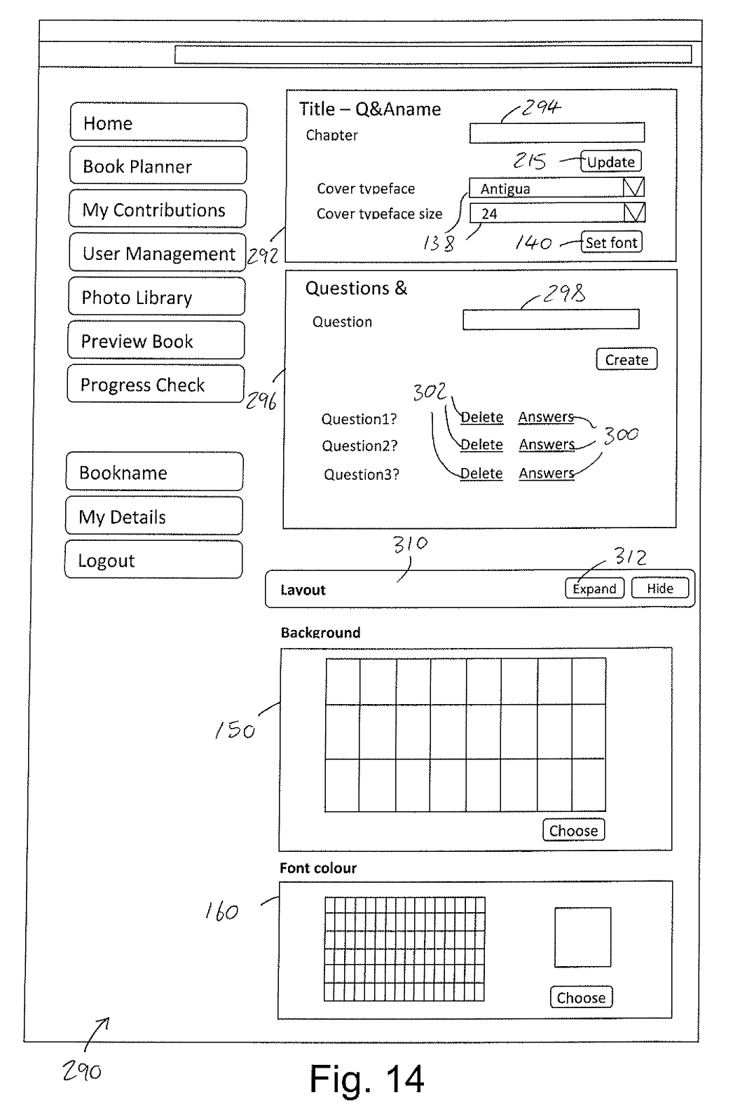

Similarly, in order to configure a newly added Q&A page, the editor selects an edit configuration button 208 on the Q&A page bar 206 on the book planning page 90 which causes a Q&A page 290 to be displayed, as shown in FIG. 14.

The Q&A page 290 includes a Q&A details box 292 usable to modify the Q&A page title by entering a new title into a Q&A title box 294 and confirm the title selection with an update button 215. As with the article configuration page 210 shown in FIG. 9, the typeface type and size to use for the Q&A page are selectable using typeface dropdown boxes 138, and the selection is confirmed using a set font button 140.

As with the article page 210, the Q&A page 290 also includes a background selection box 150 usable to select the background theme for the Q&A page, and a font colour selection box 160 usable to select the font colour for the Q&A page from a plurality of available colours 162.

The Q&A page 290 also includes a question box 296 having a question field 298 usable to add questions. After creating one or more questions, the questions appear in the question box 296. Answers to questions may be viewed by clicking on answers links 300, and questions may be deleted by clicking on delete links 302.

The Q&A page 290 also includes a layout bar 310 which when expanded by clicking on an expand button 312 can be used to select a page layout for the Q&A page.

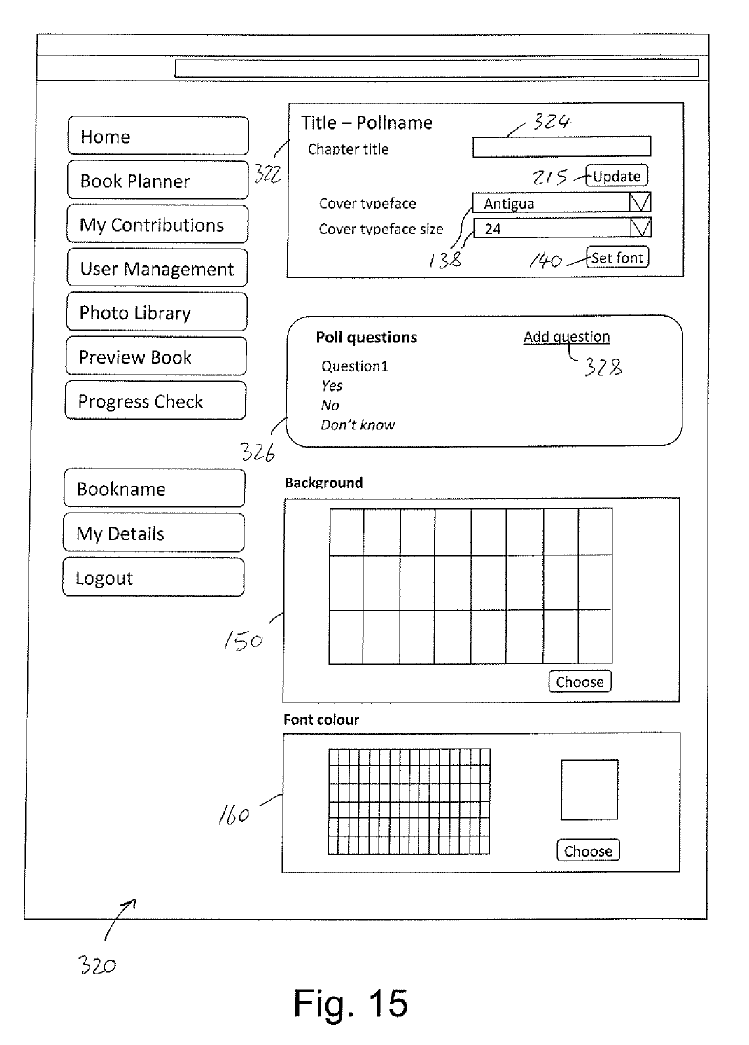

Similarly, in order to configure a newly added poll page, the editor selects a configuration button 208 on the poll page bar 206 which causes a poll configuration page 320 to be displayed, as shown in FIG. 15.

The poll configuration page 320 includes a poll details box 322 usable to modify the poll page title by entering a new title into a poll title box 324 and confirm the title selection with an update button 215. As with the article configuration page 210 shown in FIG. 9, the typeface type and size to use for the poll page are selectable using typeface dropdown boxes 138, and the selection confirmed using a set font button 140.

As with the article configuration page 210, the poll configuration page 320 also includes a background selection box 150 usable to select the background theme for the poll page, and a font colour selection box 160 usable to select the font colour for the poll page from a plurality of available colours 162.

The poll page 320 also includes a poll question box 326 having a question link 328 usable to add questions of the type including at least two selectable answers. After creating one or more questions, the questions appear in the poll question box together with available answers.

Each of the new page bars 206 on the book planning page 90 also includes a TOC toggle field 325 usable to mark the page for inclusion or not in the table of content page of the project lock button 327 usable to prevent further modification by any other user, and a delete button 329 usable to delete the page from the project.

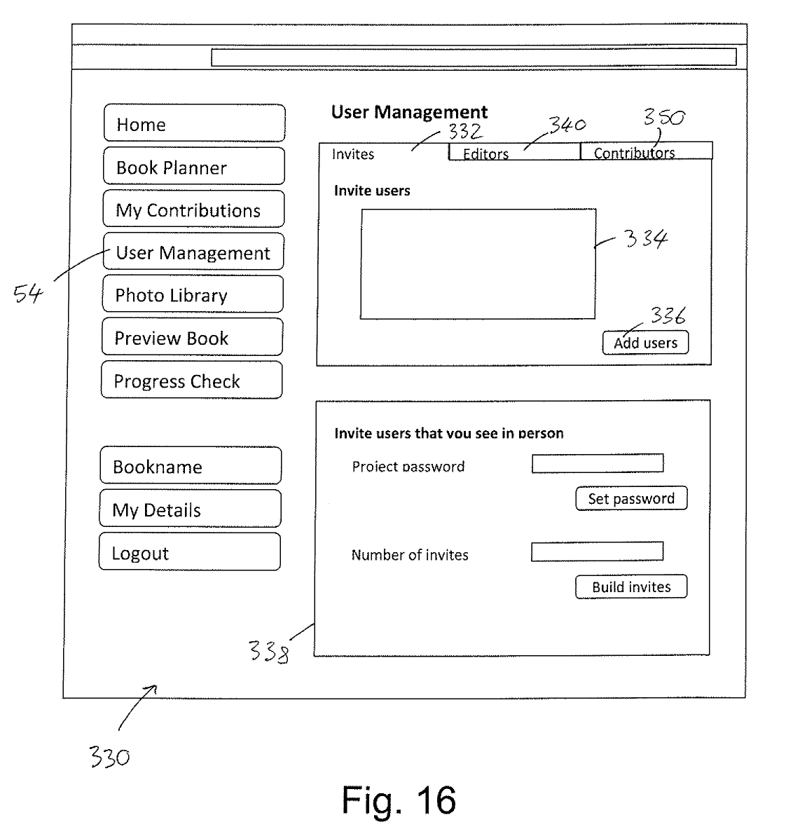

New contributors can be added to the project so that the contributors are available for selection in contributor drop down boxes by activation of a user management task button 54 on the editor home page 42 shown in FIG. 3. This causes a user management page 330 as shown in FIG. 16 to be displayed. The user management page 330 includes an invite tab 332 which when selected enables an editor to add one or more email addresses of proposed new contributors into an email address field 334. After adding the desired email addresses and clicking on an add user button 336, emails are sent by the system 10 to the entered email addresses inviting the users associated with the email addresses to be added to the project as contributors for specific tasks. The email includes a link usable to confirm acceptance of the invitation to become a contributor, and details of a login name and password usable to login to the system 10. By clicking on a link provided in the email, a message is sent to the system to indicate that the user agrees to become a contributor.

Prospective contributors may also be added by entering appropriate details into an invite box 338.

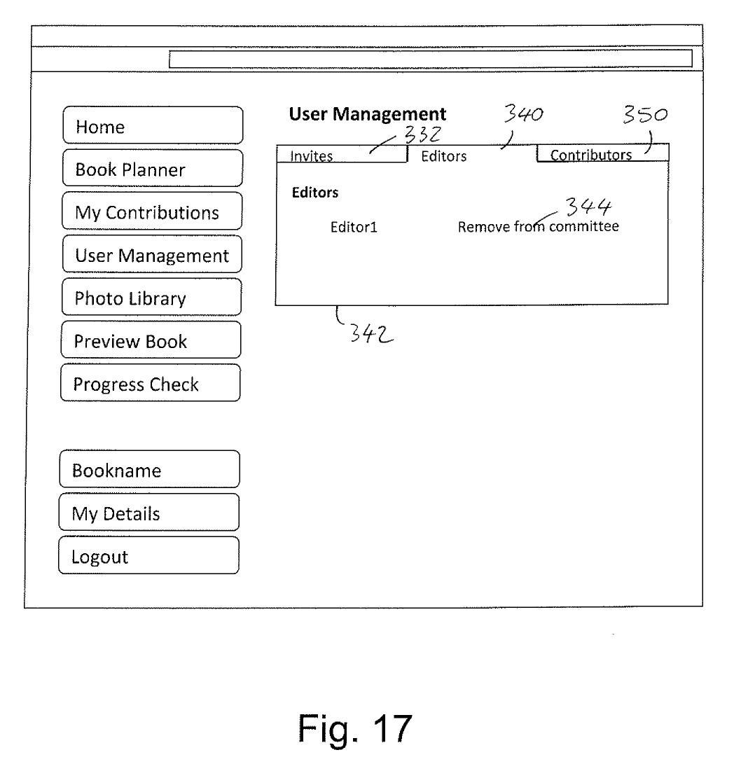

The user management page 330 also includes an editors tab 340 which when selected displays an editors box 342, as shown in FIG. 17, the editors box listing the editors assigned to the project and including a remove link 344 usable to remove an editor from the list of editors assigned the task of creating the structure of and editing the project.

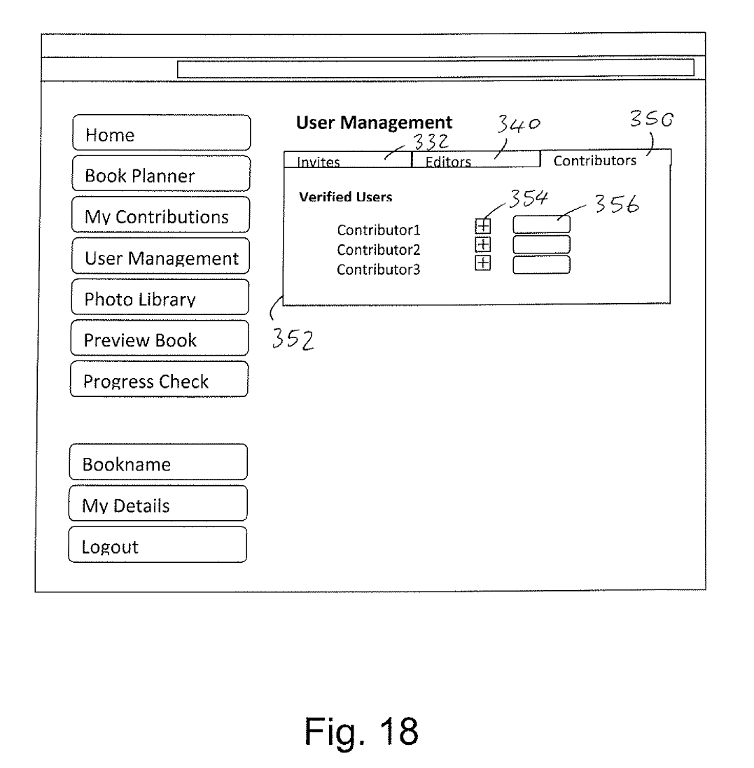

The user management page 330 also includes a contributors tab 350 which when selected displays a contributors box 352, as shown in FIG. 18, the contributors box 352 listing the contributors added to the project. A contributor may be made an editor by clicking on an add to editors icon 354, and a contributor may be deleted by clicking on a delete button 356.

When a person receives an email from the system indicating that the person is invited to become a contributor and the person has accepted the invitation, in this example by clicking on a link included in the email, the new contributor is able to login to the system 10 as a contributor. As such the contributor is assigned a level of access to the system 10 which is different to an editor. Unlike an editor, a contributor is not able to modify the basic structure of the project and instead is able only to contribute content to the project.

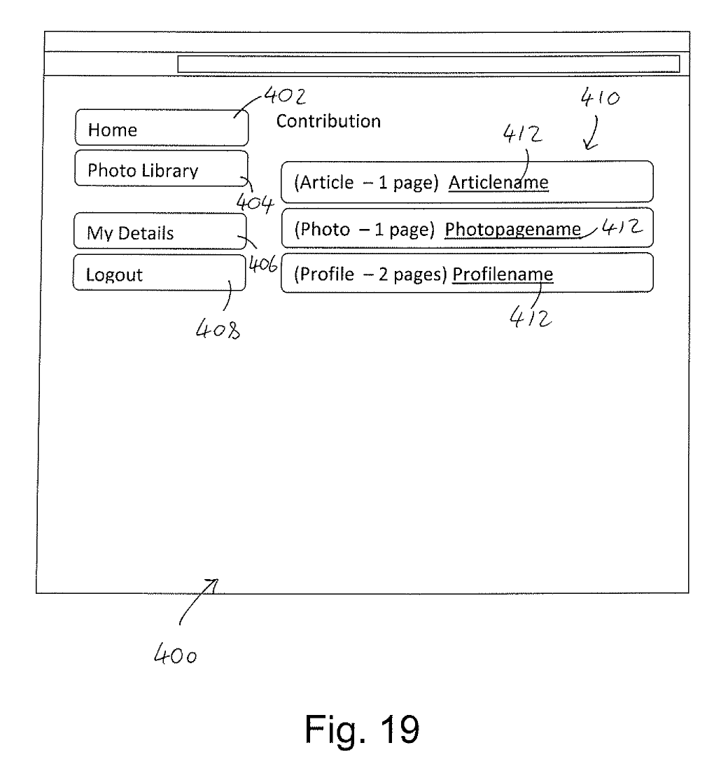

An example contributor home page 400 is shown in FIG. 19.

The contributor home page 400 includes a home navigation button 402 usable to direct the browser to display the contributor home page 400, a photo library navigation button 404, a my details button 406, and a logout button 408.

By selecting the photo library navigation button 404, a contributor is able to select locally stored images and upload the images to the system for storage in the database 18. In this example, the images uploaded by a contributor are associated with the contributor in the database so that the contributor can select from the uploaded images for example as part of a contribution to a profile page.

The contributor home page 400 includes details bars 410 indicative of pages of the project that the contributor is requested by the editor to contribute to. In the present example, the contribution details bars 410 include details of a request to contribute to an article page, to a passport photo page, and to a profile page. Each of the contribution details bars 410 includes a contribution link 412 usable to direct the browser 46 to display content pages which may be used by contributors to add content.

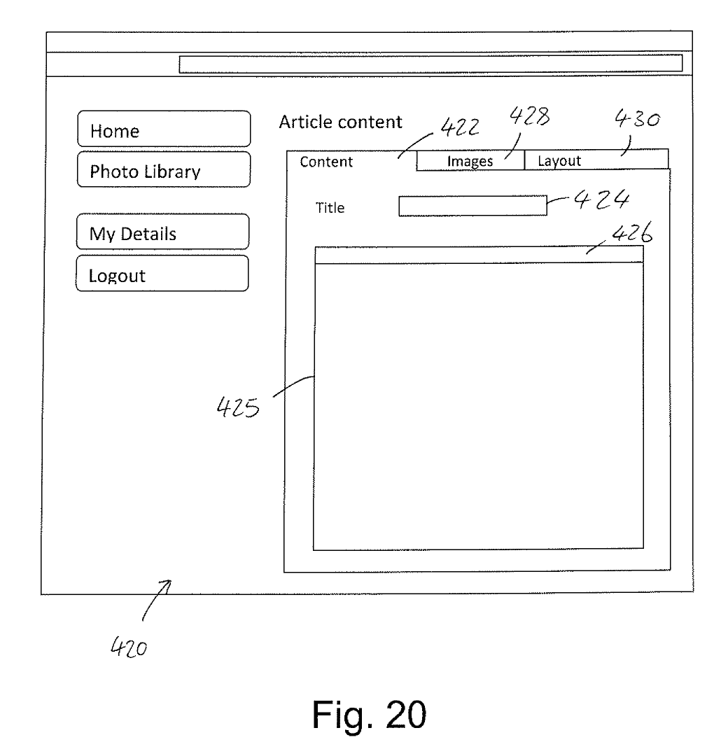

For example, when a contributor clicks on a contribution link 412 on a contribution bar 410 associated with an article, an article content page 420 is displayed, as shown in FIG. 20.

The article content page 420 includes a content tab 422 which when activated causes display of a title field 424 and an article content box 426 configured to receive text. In this example, the article content box also includes a wordprocessing toolbar 426 to assist the contributor during composition of the article.

The article content page 420 includes an images tab 428 usable to link one or more images to the article from the bank of images associated with the contributor which have been uploaded to the system 10, and a layout tab 430 usable to define the page layout for the article.

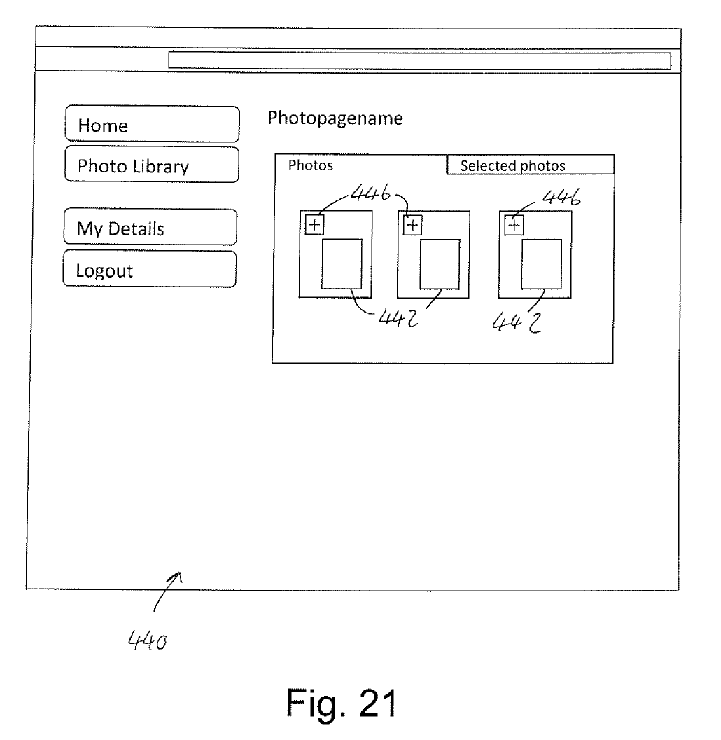

An example of a photopage content page 440 is shown in FIG. 21. Using the photopage content page 440, a contributor is able to link one or more photos 442 with a photopage by clicking on add photo icons 446. Photos which have been selected for inclusion in a photopage are viewable by clicking on a selected photos tab 450.

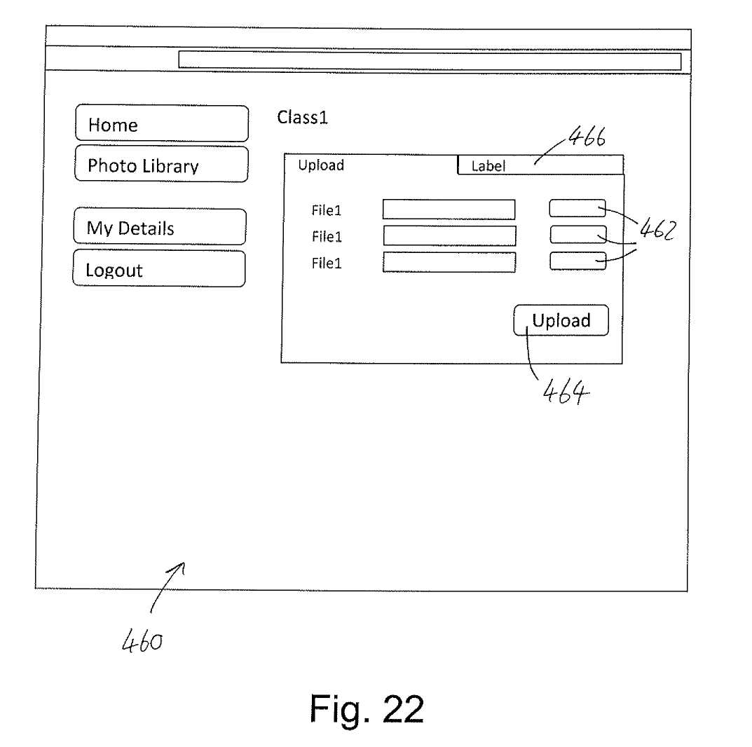

An example of a passport photo content page 460 relating to a class of students is shown in FIG. 22. Using the passport photo content page 460, a contributor assigned the task of collecting and uploading all passport photos for a class is able to locate one or more passport photos using browse buttons 462, and upload the photos using an upload button 464. The passport photos may be organized by order of importance or by other criteria using a label tab 466.

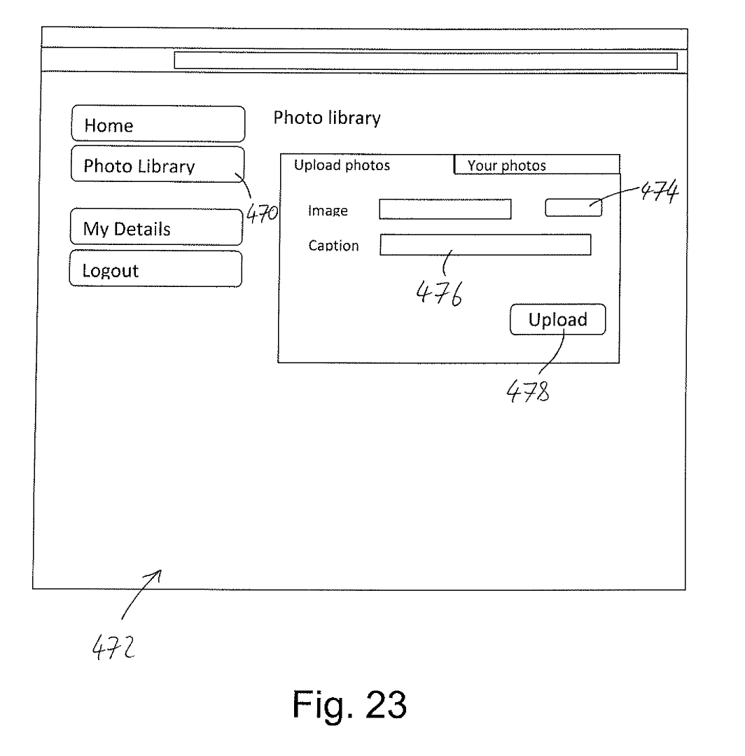

As shown in FIG. 23, when a photo library navigation button 470 is activated, a photo library page 472 is displayed which enables a contributor to upload images such as photos to the system 10 so that the images appear in a bank of images associated with the contributor and available for inclusion project pages. Using the photo library page 472, a contributor is able to locate one or more images using a browse button 474, to optionally add a caption for the image using a caption field 476, and upload the images using an upload button 478.

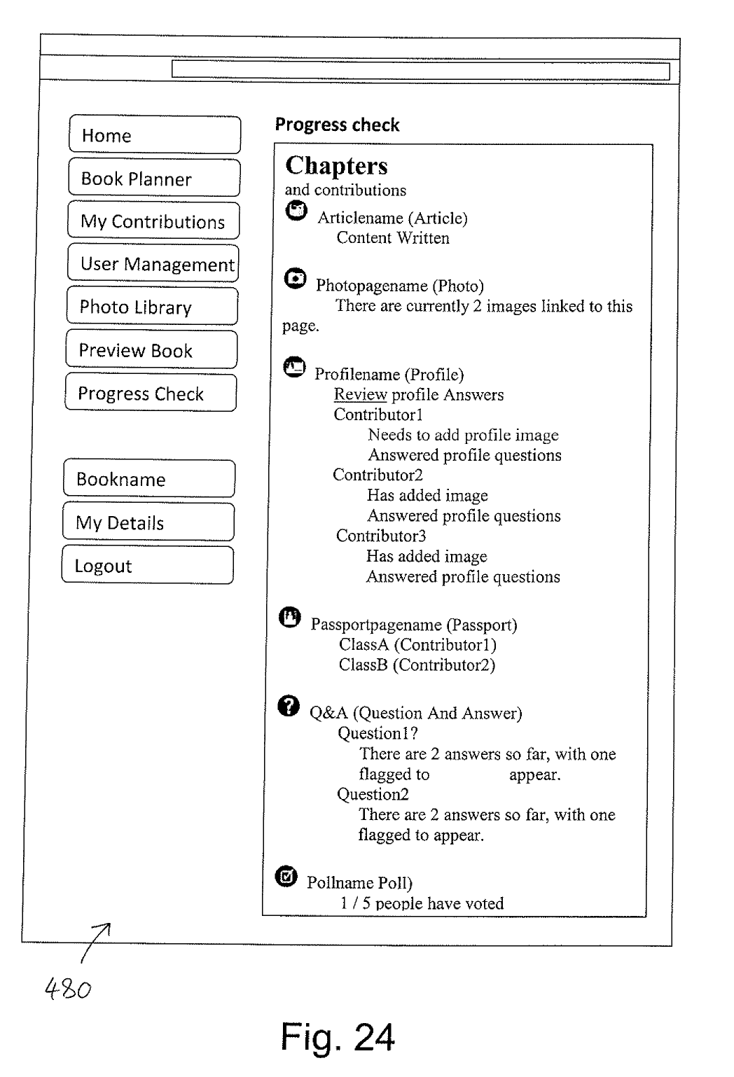

During the process of creating a document using the system 10, an editor may monitor the progress of contributions by clicking on the progress check button 60. This causes display of a progress report screen 480, as shown in FIG. 24, the progress report screen 480 itemizing each page in the project and providing a status report as to whether all contributions have been received for the page, who the relevant contributors are, any outstanding actions and so on.

When the structure and content of the publication has been finalized, an editor clicks on the book printing task button 86 which causes data indicative of the publication to be sent to the printer 28.

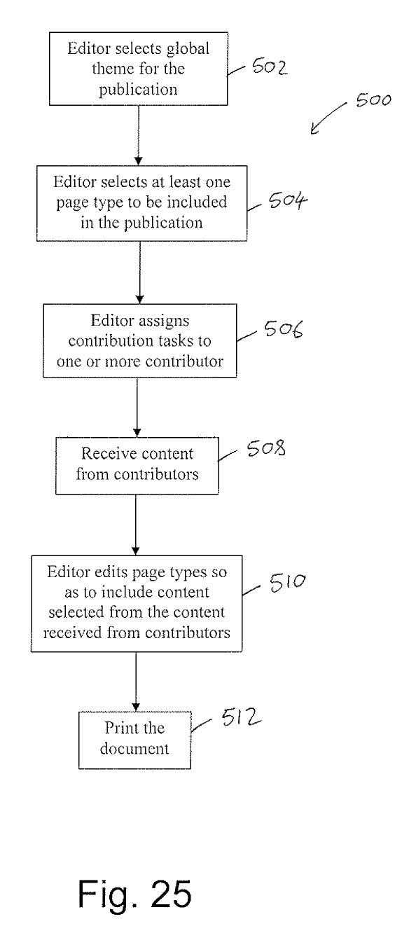

A method of producing a print ready electronic publication according to an embodiment of the invention is illustrated in flow diagram 500 in FIG. 25.

As illustrated in the flow diagram, in one implementation of the method, an editor first creates 502 a global framework for a document to be created and printed, the global framework defining the global theme to be used for the publication. The editor then selects 504 at least one page type to be included in the publication and modifies the layout of the page types as required. After the basic page layout of the publication has been defined by the editor, the editor assigns contribution tasks to one or more contributor 506, which results in reception 508 of content from the assigned contributors. After reception of content from assigned contributors, the editor selects content 510 to be included in at least some of the page types and when the layout and content of the publication has been finalized the editor causes the publication to be printed 512.

Modifications and variations as would be apparent to a skilled addressee are deemed to be within the scope of the present invention.

1. A publishing system for producing a print ready electronic publication, the system comprising:
a data storage device arranged to store structure data indicative of the structure of a publication and content data indicative of content usable in the publication;
the system being arranged to facilitate creation of a publication structure by a first user group comprising at least one first user, the publication structure being arranged to receive publication content; and
the system being arranged to facilitate reception of content from a second group of users including at least one second user;
wherein the content and location of the content in the publication structure is selectable by one or more first user from the content received from the second user group.

2. A publishing system as claimed in claim 1, wherein at least one first user is also included in the second user group.

3. A publishing system as claimed in claim 1, wherein the data storage device comprises an images repository arranged to store a plurality of images received from at least the second user group.

4. A publishing system as claimed in claim 3, wherein the system is arranged such that images stored in the images repository are selectable for inclusion in the publication structure by a first user.

5. A publishing system as claimed in claim 1, wherein the system is arranged to facilitate modification of a stored image.

6. A publishing system as claimed in claim 5, wherein the system is arranged to facilitate cropping and/or resizing of a stored image.

7. A publishing system as claimed in claim 1, wherein the data storage device comprises a database.

8. A publishing system as claimed in claim 7, wherein the database is a relational database.

9. A publishing system as claimed in claim 1, comprising a plurality of predefined project themes, each project theme defining a global theme for the publication to be produced by the publishing system and the project theme being selectable by a first user.

10. A publishing system as claimed in claim 1, wherein the publication structure comprises a plurality of predefined page types, each page type being configured to receive content, and the system being arranged to facilitate selection of one or more predefined page types for inclusion in the publication structure.

11. A publishing system as claimed in claim 10, wherein the predefined page types include an article page configured to receive one or more articles written by one or more second users; a photo page configured to receive one or more images; a profile page configured to receive information specific to second users such as answers to questions put to second users and images relevant to the second users; a passport photos page configured to receive passport type photos; a group photo page configured to receive group photos; a question & answer page configured to receive questions to be put to second users and answers received from the second users; a poll page configured to receive multiple choice questions to be put to second users and answers received from the second users; a before & after page configured to receive images of people at different times; an autograph page having one or more spaces intended to receive hand written messages on the printed document; and/or a graphic page configured to receive graphic design type images.

12. A publishing system as claimed in claim 10, wherein the system is arranged such that for at least one page type, at least one second user is selectable by a first user to contribute content to the page type.

13. A publishing system as claimed in claim 10, wherein the system is arranged such that for at least one page type, all second users associated with the publication are automatically assigned a task of contributing to the page type.

14. A publishing system as claimed in claim 1, wherein the system is arranged such that each user has associated unique login details usable to facilitate access to the system by the user and determine the level of access permitted.

15. A publishing system as claimed in claim 12, wherein the system is arranged so as to communicate to a second user when the second user has been selected by a first user to contribute to a page type.

16. A publishing system as claimed in claim 15, wherein the communication is in the form of an email.

17. A publishing system as claimed in claim 15, wherein the system is arranged such that each user has associated unique login details usable to facilitate access to the system by the user and determine the level of access permitted, and the communication includes login details usable by the second user to access the system.

18. A publishing system as claimed in claim 12, wherein the system is arranged such that when a second user accesses the system, a list of page types in respect of which the second user has been selected to contribute is displayed.

19. A publishing system as claimed in claim 10, wherein the system is arranged to facilitate modification of the order of the page types in the publication.

20. A publishing system as claimed in claim 19, wherein the system is arranged to facilitate modification of the order of the page types in the publication by enabling identifiers representing the page types to be moved on a display so as to modify the order of the identifiers and thereby the order of the page types associated with the identifiers.

21. A publishing system as claimed in claim 10, wherein the system is arranged to automatically create a table of contents based on the page types included in the publication.

22. A publishing system as claimed in claim 1, wherein the system comprises a web interface arranged to facilitate communications between the system and the first and second users through the Internet.

23. A publishing system for producing a print ready electronic publication, the system comprising:
a data storage device arranged to store structure data indicative of the structure of a publication and content data indicative of content usable in the publication;
a plurality of predefined page types, each page type being configured to receive content;
the system being arranged to facilitate selection of one or more predefined page types for inclusion in a publication structure;
the system being arranged to facilitate reception of content; and
the received content and location of the received content in the publication structure being selectable by one or more user.

24. A method of producing a print ready electronic publication, the method comprising:
storing structure data indicative of the structure of a publication and content data indicative of content usable in the publication;
creating a publication structure by a first user group comprising at least one first user, the publication structure being arranged to receive publication content;
receiving content from a second group of users including at least one second user; and
selecting content to be included in the publication from the received content and the location of the selected content in the publication structure by one or more first user.

25. A method as claimed in claim 24, comprising receiving images from at least the second user group, and facilitating selection of one or more images for inclusion in the publication structure by a first user.

26. A method as claimed in claim 24, comprising creating a plurality of predefined page types, each page type being configured to receive content, and facilitating selection of one or more predefined page types for inclusion in the publication structure.

27. A method as claimed in claim 26, wherein for at least one page type, at least one second user is selectable by a first user to contribute content to the page type.

27. A method as claimed in claim 27, comprising communicating to a second user when the second user has been selected by a first user to contribute to a page type.

28. A method of producing a print ready electronic publication, the method comprising:
storing structure data indicative of the structure of a publication and content data indicative of content usable in the publication;
providing a plurality of predefined page types, each page type being configured to receive content;
selecting one or more predefined page type for inclusion in a publication structure;
receiving content from one or more user associated with the system; and
selecting the content to be included in the selected page types from the received content and the location of the received content in the publication structure.
